(19) United States
(12) Patent Application Publication
(10) Pub. No.: US 2026/0222743 A1
(43) Pub. Date: Jul. 30, 2026

(54) LINE BODY TYPE SOUND-PRODUCING SPEAKER DEVICE

(71) Applicant: Yuanhao LIU, Shenzhen (CN)

(72) Inventor: Yuanhao LIU, Shenzhen (CN)

(21) Appl. No.: 19/143,990

(22) PCT Filed: Jun. 28, 2023
(86) PCT No.: PCT/CN2023/103282

§ 371 Date: Jun. 27, 2025

(30) Foreign Application Priority Data
Mar. 31, 2023 (CN) 202310379533.4
May 12, 2023 (CN) 202310539308.2

(51) Int. Cl. H04R 9/06; H04R 5/02; H04R 7/04; H04R 7/16; H04R 9/02; H04R 19/02

(52) U.S. Cl. CPC H04R 9/06; H04R 5/02; H04R 7/04; H04R 7/16; H04R 9/025; H04R 19/02; H04R 2205/022

(57) ABSTRACT

The present application relates to a line body type sound-producing speaker device, including shells (10, 50), a strip-shaped diaphragm (20), and a driving assembly (30). The strip-shaped diaphragm (20) has a line body shape and is mounted on the shell (10, 50) in a linear direction. The driving assembly (30) is mounted on the shell (10, 50) in a linear direction and is arranged parallel to the strip-shaped diaphragm (20) at intervals from each other. when the strip-shaped diaphragm (20) responds to an input of a sound source current signal, the strip-shaped diaphragm (20) is vibrated by the driving assembly (30) to generate a sound effect. The strip-shaped diaphragm (20) provides a surface sound production effect on the basis of a line sound field, so as to more easily create a sound that gives a stereophonic impression in a space.

### TECHNICAL FIELD

The present application relates to a sound effect device, and in particular to a line body type sound-producing speaker device based on an electromagnetic interaction of a strip-shaped diaphragm and a magnet assembly to generate a magnetic field.

### BACKGROUND

A sound generation principle of a speaker is an electroacoustic principle, which converts electrical energy into mechanical energy, and then converts the mechanical energy into sound. The speaker is divided into two parts: a transmitting element and a driving element. The transmitting element is usually a film, coil or diaphragm, while the driving element is usually realized by a power amplifier and a driving circuit. A sound generation process of the speaker is to convert electrical signals into mechanical energy, then the film or diaphragm generates sound waves, and finally the driving element converts the mechanical energy into sound to achieve sound generation.

A sound generation principle of existing traditional loudspeakers is generally based on point sound. Sound source gradually diffuses outward from the point. A diffusion process progressively attenuates, making a sound transmission distance closer, which means that the volume cannot be adjusted very loudly and the sound cannot be emitted very loudly. If multiple point sound sources are selected to be combined into various patterned arrays, multi-band interference will occur, surface sound effect cannot be provided, air-driven sound efficiency is not high, and sound effect and sound quality are not perfect.

### SUMMARY

One advantage of the present invention is to provide a line body type sound-producing speaker device, which is based on the electromagnetic interaction of a strip-shaped diaphragm and a magnet assembly to generate a magnetic field and generate a linear-type sound-emitting surface, so that the sound effect can be expanded along the linear-type sound-emitting surface.

Another advantage of the present invention is to provide the line body type sound-producing speaker device. Unlike traditional speakers that form a point-like sound field, the strip-shaped diaphragm provides a surface sound effect based on a line sound field, so as to more easily form a sound having a three-dimensional sense in a space.

Another advantage of the present invention is to provide the line body type sound-producing speaker device, which is based on the strip-shaped diaphragm that emits sound along a linear-type sound-emitting surface to reduce mutual interference between sound bands.

Another advantage of the present invention is to provide the line body type sound-producing speaker device, the line body type sound-producing speaker device is suitable for linearly extending deeply in a length direction, thereby facilitating the provision of a continuous line body type sound-producing field in an ambient space as desired.

Another advantage of the present invention is to provide the line body type sound-producing speaker device, in which the magnet assembly is arranged in a strip shape to adapt to the strip-shaped diaphragm and provide the strip-shaped diaphragm with a surrounding magnetic field in a linear direction, which can effectively interact with the strip-shaped diaphragm.

Another advantage of the present invention is to provide the line body type sound-producing speaker device, in which the strip-shaped diaphragm is arranged with linear circuits, and the linear circuits are located in a magnetic field environment of the magnet assembly. When a sound source current signal is input, the strip-shaped diaphragm is vibrated by the magnet assembly under the action of the magnet assembly, thereby eliminating the need for a voice coil that needs electromagnetic interaction with a magnetic field like a traditional speaker.

Another advantage of the present invention is to provide the line body type sound-producing speaker device, in which the linear circuits arranged by the strip-shaped diaphragm are suitable for being arranged at a position with a higher magnetic field intensity in the magnet assembly, thereby strengthening the vibration effect of the strip-shaped diaphragm and enhancing the sound effect of the strip-shaped diaphragm.

Another advantage of the present invention is to provide the line body type sound-producing speaker device, the magnet assembly may include a single magnet or a plurality of magnets, and when the magnet assembly includes the plurality of magnets, two adjacent magnets have opposite magnetic poles on the same plane, so that a strong magnetic field is generated between the opposite magnetic poles on the plane, so that the linear circuit of the strip-shaped diaphragm arrangement between the two magnetic poles can be vibrated by the strong magnetic field to produce sound effect.

Another advantage of the present invention is to provide the line body type sound-producing speaker device, in which the strip-shaped diaphragm and a bracket of the magnet assembly are provided with ventilation holes to facilitate the outward transmission of vibration generated by the strip-shaped diaphragm.

Another advantage of the present invention is to provide the line body type sound-producing speaker device, which uses the strip-shaped diaphragm of a strip-shaped metal conductive film to adapt to the line body type sound-producing speaker device to provide higher accuracy and dynamic range, provide higher sound quality and more reliability, and provide lower noise levels and a wider frequency response range.

Another advantage of the present invention is to provide the line body type sound-producing speaker device, in which the strip-shaped diaphragm has a thin thickness and produces pure sound effects when vibrating, especially good mid-and high-frequency sound effects, and the line body type sound-producing speaker device can be matched with a bass sound device, thereby providing a more full-range sound effect.

Another advantage of the present invention is to provide the line body type sound-producing speaker device, the sound speaker device can be arranged in an indoor or outdoor environment according to the needs of a user, and a plurality of the line body type sound-producing speaker devices can be spliced together to construct a three-dimensional stereo sound field from two upper sound fields, which can be infinitely extended and combined into various patterns and shapes in practical application to form different sound field effects, so that it can realize various surface sound sources.

Another advantage of the present invention is to provide the line body type sound-producing speaker device, in which two strip-shaped diaphragms are arranged on opposite sides of the magnet assembly, so that the opposite sides of the line body type sound-producing speaker device are Sound effects can be produced on both sides.

Another advantage of the present invention is to provide the line body type sound-producing speaker device, which is also provided with a linearly arranged light source, which provides a luminous effect while the strip-shaped diaphragm emits sound effects, so that it can be matched according to different sound effects. Different lighting effects to provide users with stronger sound and light interaction effects.

Another advantage of the present invention is to provide the line body type sound-producing speaker device, which can also be equipped with a dynamic speaker, thereby providing full-frequency sound effects and reducing its cost.

The present invention provides a line body type sound-producing speaker device, which includes:
a shell;
one or more strip-shaped diaphragms; and
one or more driving assemblies, where the strip-shaped diaphragm is in a line body shape and is mounted on the shell along a linear direction, the driving assembly is mounted on the shell along a linear direction and arranged in parallel with the strip-shaped diaphragm at intervals from each other, and when the strip-shaped diaphragm responds to an input of a sound source current signal, the strip-shaped diaphragm is vibrated by the driving assembly to generate a sound effect.

According to some embodiments, the strip-shaped diaphragm includes a diaphragm base, a conductive circuit, and a set of terminals, where the conductive circuit is attached to the diaphragm base and is located in a space above the magnet assembly, and the set of terminals are electrically connected to the conductive circuit to supply electrical energy to the conductive circuit and input the sound source current signal to the conductive circuit.

According to some embodiments, the driving assembly is a magnet assembly including one or more magnets arranged in the linear direction, and the conductive circuit comprises one or more linear circuits extending along a length direction of the strip-shaped diaphragm and is located in the magnetic field environment of the magnet of the magnet assembly. When the set of terminals inputs the sound source current signal, the linear circuits are affected by the magnetic field of the magnet assembly, causing the diaphragm base to vibrate accordingly and produce sound.

According to some embodiments, the magnet of the magnet assembly forms a magnetic pole surface facing the strip-shaped diaphragm, the strip-shaped diaphragm has a diaphragm surface facing the magnet assembly, the magnetic pole surface and the diaphragm surface are parallel to each other, and a linear extension direction of the arrangement of the magnet and an extension direction of the linear circuits are arranged in a staggered manner.

According to some embodiments, the magnet assembly includes a plurality of columns of the magnets, the magnets in the same column are arranged in the same magnetic pole direction, and two adjacent columns of the magnets having opposite magnetic poles on a side facing the strip-shaped diaphragm.

According to some embodiments, one of the plurality of columns of the magnets is located below a position between two adjacent of the linear circuits of the corresponding strip-shaped diaphragm.

According to some embodiments, the conductive circuit includes a plurality of linear portions, each of the plurality of linear portions includes a plurality of the linear circuits, each column of magnets includes a plurality of the magnets, and an intermediate position of each two adjacent of the linear circuits of each of the linear portions corresponds to one of the magnets with a strip shape.

According to some embodiments, the driving assembly includes two driving electrodes located on opposite sides of the strip-shaped diaphragm and changing polarity through voltage conversion to drive the strip-shaped diaphragm implemented as an electrostatic diaphragm.

According to some embodiments, the housing includes a tubular housing and a bracket, and the strip-shaped diaphragm and the magnet assembly are installed on the bracket and located in the tubular housing.

According to some embodiments, the bracket includes a base and a fixed frame, the magnet assembly is installed on the base, the strip-shaped diaphragm is installed on the fixed frame, a vibration space is formed between the strip-shaped diaphragm and the base, the base has one or more ventilation holes, a communication space is formed on a bottom side of the base, and the vibration space and the communication space are connected through the ventilation holes.

According to some embodiments, the shell includes a first shell portion and a second shell portion, the strip-shaped diaphragm is installed on the first shell portion, the magnet assembly is installed on the second shell portion, and the first shell portion and the second shell portion are assembled.

According to some embodiments, the magnet is one selected from a group consisting of a strip magnet, a columnar magnet, and a ring magnet.

According to some embodiments, the line body type sound-producing speaker device includes two strip-shaped diaphragms, wherein the two strip-shaped diaphragms are located on opposite sides of the same magnet assembly.

According to some embodiments, the line body type sound-producing speaker device further includes a dynamic speaker installed on the shell to jointly respond to the input of the sound source current signal with the strip-shaped diaphragm to produce sound effects at the same time.

According to some embodiments, when the linear speaker device includes a plurality of dynamic speakers, and the plurality of dynamic speakers are alternately linearly arranged with a plurality of loudspeakers formed by the strip-shaped diaphragm and the driving assembly.

According to some embodiments, the line body type sound-producing speaker device further includes a light source, and the light source includes one or more light bars arranged along a length direction of the shell.

According to some embodiments, the shell includes a tubular housing and a bracket, the light bar is installed on the bracket and is located in the tubular housing, and the tubular housing has a plurality of through holes.

### BRIEF DESCRIPTION OF THE DRAWINGS

FIG. 1 is a schematic perspective view of a line body type sound-producing speaker device according to a first preferred embodiment of the present invention.

FIG. 2 is an exploded schematic view of the line body type sound-producing speaker device according to the above-described first preferred embodiment of the present invention.

FIG. 3 is a schematic cross-sectional view of the line body type sound-producing speaker device according to the above-described first preferred embodiment of the present invention.

FIG. 4 is a schematic structural diagram of a strip-shaped diaphragm of the line body type sound-producing speaker device according to the first preferred embodiment of the present invention.

FIG. 5 is an exploded schematic view of the line body type sound-producing speaker device according to a first modified embodiment of the first preferred embodiment of the present invention.

FIG. 6 is a schematic structural diagram of a strip-shaped diaphragm of the line body type sound-producing speaker device according to the first modified embodiment of the above-described first preferred embodiment of the present invention.

FIG. 7 is an exploded schematic view of a line body type sound-producing speaker device according to a second modified embodiment of the first preferred embodiment of the present invention.

FIG. 8 is a schematic structural diagram of a strip-shaped diaphragm of the line body type sound-producing speaker device according to the second modified embodiment of the first preferred embodiment of the present invention.

FIG. 9 is an exploded schematic view of the line body type sound-producing speaker device according to the second preferred embodiment of the present invention.

FIG. 10 is a schematic cross-sectional view of the linear speaker device according to the second preferred embodiment of the present invention.

FIG. 11 is a schematic structural diagram of a strip-shaped diaphragm of the line body type sound-producing speaker device according to the second preferred embodiment of the present invention.

FIG. 12 is an exploded schematic view of the line body type sound-producing speaker device according to a first modified embodiment of the second preferred embodiment of the present invention.

FIG. 13 is a schematic structural diagram of a strip-shaped diaphragm of the line body type sound-producing speaker device according to the first modified embodiment of the second preferred embodiment of the present invention.

FIG. 14 is an exploded schematic view of the line body type sound-producing speaker device according to a second modified embodiment of the second preferred embodiment described above of the present invention.

FIG. 15 is a schematic structural diagram of a strip-shaped diaphragm of the line body type sound-producing speaker device according to the second modified embodiment of the second preferred embodiment of the present invention.

FIG. 16 is an exploded schematic view of a line body type sound-producing speaker device according to a third preferred embodiment of the present invention.

FIG. 17 is a schematic cross-sectional view of the line body type sound-producing speaker device according to the third preferred embodiment of the present invention.

FIG. 18 is a schematic perspective view of a line body type sound-producing speaker device according to a fourth preferred embodiment of the present invention.

FIG. 19 is a schematic cross-sectional view of the line body type sound-producing speaker device according to the fourth preferred embodiment of the present invention.

FIG. 20 is an exploded schematic view of the line body type sound-producing speaker device according to the fourth preferred embodiment of the present invention.

FIG. 21 is a schematic cross-sectional view of a line body type sound-producing speaker device according to a fifth preferred embodiment of the present invention.

FIG. 22 is a schematic cross-sectional view of a line body type sound-producing speaker device according to a sixth preferred embodiment of the present invention.

FIG. 23 is an exploded schematic view of the line body type sound-producing speaker device according to a modified embodiment of the sixth preferred embodiment of the present invention.

### DETAILED DESCRIPTION OF EMBODIMENTS

The following description is provided to disclose the invention to enable those skilled in the art to practice the invention. The preferred embodiments in the following description are only embodiments, and other obvious modifications may occur to those skilled in the art. The basic principles of the invention defined in the following description may be applied to other embodiments, variations, improvements, equivalents and other technical solutions without departing from the spirit and scope of the invention.

It will be understood by those skilled in the art that in the disclosure of the present invention, the orientation or positional relationship indicated by the terms “longitudinal”, “horizontal”, “upper”, “lower”, “front”, “back”,“left”, “right”, “vertical”, “horizontal”, “top”, “bottom”, “inner”, “outer”, etc. is based on the orientation or positional relationship shown in the drawings, and is merely intended to facilitate and simplify the description of the present invention, and does not indicate or imply that the referred device or element must have a specific orientation, be constructed and operate in a specific orientation, and therefore the above terms cannot be construed as limiting the present invention.

It is to be understood that the term “a” should be understood as “at least one” or “one or more”, i.e., in one embodiment, the number of elements may be one, while in further embodiments, the number of elements may be multiple, and the term “a” should not be understood as a limitation of the number.

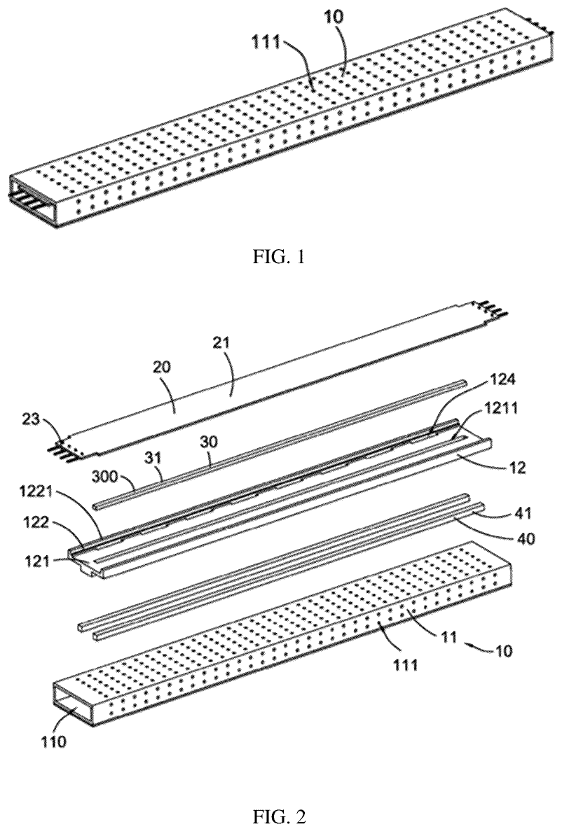

As shown in FIGS. 1 to 4, a line body type sound-producing speaker device according to the first preferred embodiment of the present invention includes a shell 10, a strip-shaped diaphragm 20, and a magnet assembly 30 implemented as a driving assembly. The strip-shaped diaphragm 20 is in a line body shape and is installed on the shell 10 along a linear direction. The magnet assembly 30 is also arranged along the linear direction. When the strip-shaped diaphragm 20 generates an electromagnetic field in response to an input of a sound source current signal, an attraction or repulsion action can be generated between the electromagnetic field and the magnetic poles of the magnet assembly 30 to drive the strip-shaped diaphragm 20 to vibrate to produce sound effects.

The strip-shaped diaphragm 20 includes a diaphragm base 21, a conductive circuit 22, and a set of terminals 23. The diaphragm base 21 is a strip-shaped film made of plastic and is in a tight state to form a flat film. The conductive circuit 22 is a made of lightweight metal material, such as aluminum foil, which is attached to the diaphragm base 21 and located in a space above the magnet assembly 30. The set of terminals 23 is electrically connected to the conductive circuit 22 to supply electric energy to the conductive circuit 22 and input the sound source current signal to the conductive circuit 22.

The conductive circuit 22 includes one or more linear circuits 221 that extends along a length direction of the strip-shaped diaphragm 20 and also extends along a length direction of the shell 10. The linear circuits 221 are located in the magnetic field environment of the magnet assembly 30. When the set of wiring terminals 23 inputs a sound source current signal, the linear circuits 221 will generate an electromagnetic field. An attraction or repulsion action can be generated between the electromagnetic field and the magnetic poles of the magnet assembly 30 to drive the strip-shaped diaphragm 20 to vibrate to generate an acoustic effect.

The magnet assembly 30 includes one or more magnets 31 arranged in the linear direction. For example, in this embodiment, the magnet assembly 30 includes an integral elongated magnet. The magnet 21 is capable of generating a magnetic field and has a property of attracting a ferromagnetic substance such as a metal, such as iron, nickel, and cobalt, and the ferromagnetic substance may be a permanent magnet or a magnetized substance having magnetism obtained after magnetization.

The linear circuit 221 is arranged near an upper of the magnet 31 without contact, so that a magnetic field generated by the magnet assembly 30 acts on an electromagnetic field generated by the linear circuit 221 after the input sound source signal, thereby driving the strip-shaped diaphragm 20 to vibrate and generate sound effect.

In this embodiment, unlike traditional speakers that use the electromagnetic action of a voice coil and a magnet to drive a drum paper connected to the voice coil to vibrate and produce sound, the strip-shaped diaphragm 20 of the present invention does not need to be connected to the voice coil. The linear circuit 221 interacts with the magnetic field of the magnet assembly 30 so that the strip-shaped diaphragm 20 vibrates and produces sound. Moreover, the strip-shaped diaphragm 20 and the magnet assembly 30 are arranged in a line shape, so that the expansion of the sound effect extends along the line-shaped direction, and the strip-shaped diaphragm 20 emits sound on a linear surface and can be extended along the linear direction to form a surface-shaped sound effect, which is different from the traditional speakers. Sound areas of the traditional speakers are limited by an end surface area of the voice coil and cannot be expanded.

That means, since the strip-shaped diaphragm 20 does not need to be connected to a driving structure similar to a voice coil, its vibration is limited by the vibration stroke of the voice coil. The strip-shaped diaphragm 20 is disposed in a floating state in a space above the magnet assembly 30. The magnet assembly 30 is arranged in a strip shape to adapt to the strip-shaped diaphragm 20 and provide the strip-shaped diaphragm 20 with a surrounding magnetic field in a linear direction which can effectively interact with the strip-shaped diaphragm. The strip-shaped diaphragm 20 only needs to be in the magnetic field environment of the magnet assembly 30, so that the strip-shaped diaphragm 20 can be continuous to develop along the length direction. And unlike traditional speakers based on voice coils and drum paper that form a point-like sound field, the strip-shaped diaphragm 20 and the magnet assembly 30 of the present invention provide a surface sound field based on a line sound field, making it easier to form a three-dimensional sound field in the space. A spatial sound field, and sound generation based on the same line can reduce mutual interference between sound bands.

As shown in FIG. 4, the strip-shaped diaphragm 20 includes two columns of linear circuits 221 spaced apart from each other. The magnet 31 is arranged in a intermediate position between the two columns of linear circuits 221 spaced apart from each other. Therefore, the two columns of linear circuits 221 spaced apart from each other are in positions where the magnetic field intensity of the magnet 31 is the strongest. So that the linear circuits 221 are in the position where the driving effect of the magnet 31 is strongest, thereby driving all the linear circuits 221. The strip-shaped diaphragm 20 vibrates to produce sound. In the embodiment shown in FIG. 4, one column of the linear circuits 221 includes one of the linear circuits 221, and another column of the linear circuits 221 includes two of the linear circuits 221 provided by bending. Therefore, these linear circuits 221 extend integrally and both opposite ends are electrically connected to the set of the terminals 23.

It can be understood that the strip-shaped diaphragm 20 is implemented as a planar magnetic diaphragm. When a music signal is sent in a form of electric current, the planar magnetic diaphragm will begin to interact with the magnetic field, causing the planar magnetic diaphragm to move back and forth to generate sound waves. In other embodiments, the strip-shaped diaphragm 20 can be implemented as an electrostatically driven diaphragm. In a changing electric field, the electrostatically driven diaphragm is also thin and can be accurately polarized to the micron level from high direct-current (DC) voltages. The required current is polarized and converted into alternating current. The electrostatic drive diaphragm is suspended in the electrostatic field generated by the metal plates passing through the two fixed plates. If the audio information is loaded onto the stator, the electrostatic field will change to drive the diaphragm to vibrate.

The shell 10 includes an outer housing 11 and a bracket 12. In this embodiment, the strip-shaped diaphragm 20 and the magnet assembly 30 are assembled on the bracket 12. The outer housing 11 is a tubular housing, and the interior of the tubular housing is hollow to form a strip-shaped accommodation cavity 110. The bracket 12, the strip-shaped diaphragm 20, and the magnet assembly 30 are all located in the outer housing 11. So that the line body type sound-producing speaker device of the present invention is formed to be a speaker tube or speaker panel.

That means, the line body type sound-producing speaker device looks like a tubular device in appearance, and its sound-generating components are accommodated in the outer housing 11. A tubular housing of the outer housing 11 extends in a long strip. Both the strip-shaped diaphragm 20 and the magnet assembly 30 accommodated in the tubular housing match a length of the tubular housing. The tubular housing of the outer housing 11 has a tubular or annular cross-section, which can be a square ring or other annular shape, as long as the strip-shaped accommodation cavity 110 is formed inside to accommodate the bracket 12 and the strip-shaped vibrator. The strip-shaped diaphragm 20 and the magnet assembly 30 are sufficient.

More specifically, the bracket 12 includes a base 121 and a fixed frame 122. In this embodiment, a magnet 31 of the magnet assembly 30 is fixed to the base 121, and the strip-shaped diaphragm 20 fixed to the fixed frame 122. The base 121 may have a positioning groove 1211 with a strip-shaped. The magnet 31 with a strip-shaped is held and fixed in the positioning groove 1211. The fixed frame 122 extends protrudingly from the base 121. For example, the fixed frame 111 includes two fixed ribs 1111, which respectively extend convexly from two opposite edges of the base 121 and form a step surface for fixing the strip-shaped diaphragm 20 fixed above the magnet assembly 30.

The strip-shaped diaphragm 20 is fixed to the fixed frame 122 and forms a vibration space 123 with the base 121. The magnet assembly 30 and the strip-shaped diaphragm 20 are also spaced apart from each other. So that the strip-shaped diaphragm 20 only needs to be located in the magnetic field environment of the magnet assembly 30.

In this embodiment, the strip-shaped diaphragm 20 forms a strip-shaped diaphragm surface 200. The magnet assembly 30 forms a magnetic pole surface 300. Preferably, the strip-shaped diaphragm surface 200 and the magnetic pole surface 300 are parallel to each other, thereby facilitating the magnetic field formed by the magnet assembly 30 to act on the strip-shaped diaphragm surface 200.

The bracket 12 is formed with one or more ventilation holes 124, and a communication space 125 is formed on a bottom side of the bracket 12. The ventilation holes 124 connect the vibration space 123 to the communication space 125, so that when the strip-shaped diaphragm 20 vibrates, the air in the vibration space 123 can be stirred to facilitate transmission of sound. In this embodiment, for example, two columns of the ventilation holes 124 may be formed on the base 121 of the bracket 12, that means, through a thickness of the base 121, so as to communicate the vibration space 123 above the base 121 with the communication space 125 on a bottom side of the base 121.

The shell 10 may also be provided with an attachment element 13 on the bottom side of the outer housing 11, which is used to fix the shell 10 to an environment surface, thereby fixing the line body type sound-producing speaker device to the environment surface. The attachment elements 13 can be various installation elements, such as screws and nuts, rivets, buckle structures, and other connecting elements, or can also be adhesive elements such as tape, so as to facilitate to adhered and fixed the line body type sound-producing speaker device to the environment surface. It can be understood that when the line body type sound-producing speaker device is embedded in the environmental surface, the attachment element 13 can also be provided on the side of the shell 10, For example, a tape is provided on the side of the shell 10 and/or the bottom of the shell 10.

It is worth mentioning that the linear speaker device can also include a light source 40, which are linearly arranged and provides a luminous effect while the strip-shaped diaphragm 20 emits sound effects, so that it can be matched according to different sound effects. Different lighting effects to provide users with stronger sound and light interaction effects.

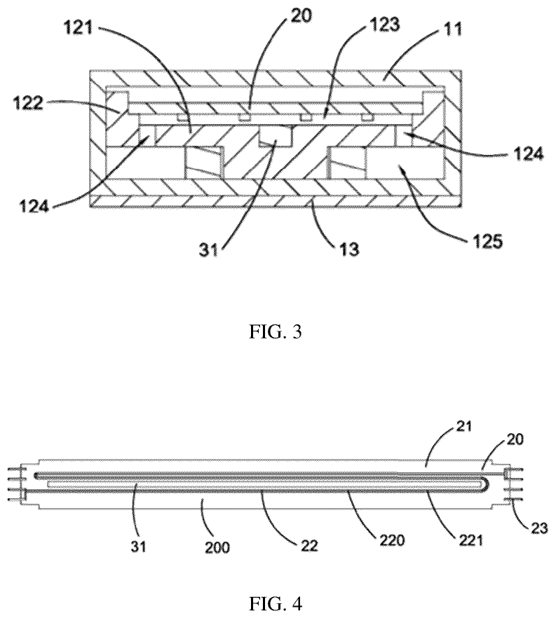

As shown in FIGS. 2 and 3, the light source 40 may include two light bars 41, and each light bar 41 may include one or more LED light-emitting elements, OLED light-emitting elements, fluorescent light-emitting elements, etc. Each light bar 41 can be a colorful light strip to provide a display of colored light, and provide different colored light illumination effects according to the intensity of the sound source current signal input by the strip-shaped diaphragm 20, thereby enriching the sound and light interaction with the user. content. When the linear speaker device receives a voice command from a person, the light source 40 can also use the light status change to feedback the result of the voice interaction, so that the interaction between the device and the person is more intuitive and simple, and thus different application requirements of the person can be met. For example, when a plurality of the line body type sound-producing speaker devices of the present invention are arranged in an indoor environment, soft light or light with rich colors and large contrast changes can be provided according to the user's needs.

In this embodiment, the light bar 41 is schematically installed on both sides of the bottom of the base 121 of the bracket 12 and is located in the communication space 125. It can be understood that the light source 40 can also be installed on other places, such as on the outer housing 11.

It can be understood that, in order to allow the light emitted by the light source 40 installed in the shell 10 to be projected to the outside of the shell 10, and the outer housing 11 of the shell 10 may be provided with a plurality of through holes 111, so that the light emitted by the light source 40 can pass through the through holes 111, and the through holes 111 can also be used to allow the sound effects generated by the strip-shaped diaphragm 20 to propagate.

In addition, the plurality of the line body type sound-producing speaker devices can be easily spliced. For example, the outer housing 11 implemented as a tubular housing can be spliced together. A plurality of the line body type sound-producing speaker devices can be spliced together to construct a three-dimensional stereo sound field from two upper sound fields, which can be infinitely extended and combined into various patterns and shapes in practical application to form different sound field effects, so that it can realize various surface sound sources.

That means, the line body type sound-producing speaker device is suitable for modular assembly. As a modular unit, the line body type sound-producing speaker device can be quickly assembled to form the required facial shape. speaker matrix.

Correspondingly, a manufacturing method of the line body type sound-producing speaker device of the present invention includes a step of assembling the strip-shaped diaphragm 20, a step of assembling the magnet assembly 30, a step of assembling the light source 40, and a final step of assembling the shell 10.

In the step of assembling the strip-shaped diaphragm 20, the strip-shaped diaphragm 20 is fixed to the fixed frame 122 of the bracket 12 in a straight state. In the step of assembling the magnet assembly 30, the magnet 31 of the magnet assembly 30 is assembled in the positioning groove 1211 of the bracket 12, and is spaced apart from the strip-shaped diaphragm 20. The magnetic pole surface 300 on the top side of the magnet assembly 30 and the strip-shaped diaphragm surface 200 of the strip-shaped diaphragm 20 are arranged in parallel and spaced apart from each other.

In the step of assembling the light source 40, one or more light bars 41 are assembled on the bracket 12 or the outer housing 11. In the final step of assembling the shell 10, the bracket 12 with the strip-shaped diaphragm 20, the magnet assembly 30, and the light source 40 is assembled in the outer housing 11 with a tubular shape, so that the bracket 12 and the outer housing 11 form an integral housing assembly.

Correspondingly, the present invention provides a line body type sound-producing generation method, which includes the following steps:
inputting the sound source current signal into the conductive circuit 22 of the strip-shaped diaphragm 20; and
driving the strip-shaped diaphragm 20 to emit sound on the wire surface by the interaction between the conductive circuit 22 and the magnetic field of the magnet assembly 30.

The strip-shaped diaphragm 20 and the magnet assembly 30 are arranged along the strip-shaped receiving cavity 110 of the outer housing 11 of the shell with a tubular shape to form a line body type sound-producing speaker.

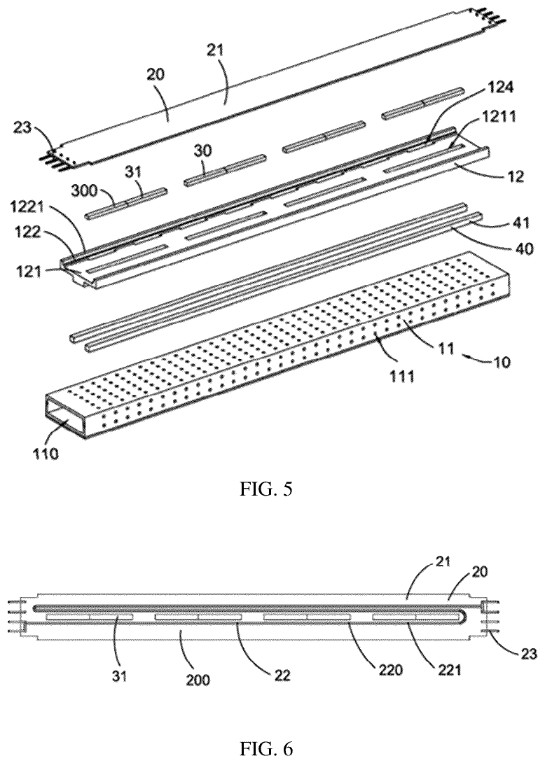

As shown in FIGS. 5 and 6, according to a first variant of the first preferred embodiment of the present invention, the magnet assembly 30 includes a plurality of magnets 31 arranged along a linear direction. The base 121 of the bracket 12 of the shell 10 correspondingly has a plurality of positioning grooves 1211 with a strip shape for accommodating and positioning the magnets 31.

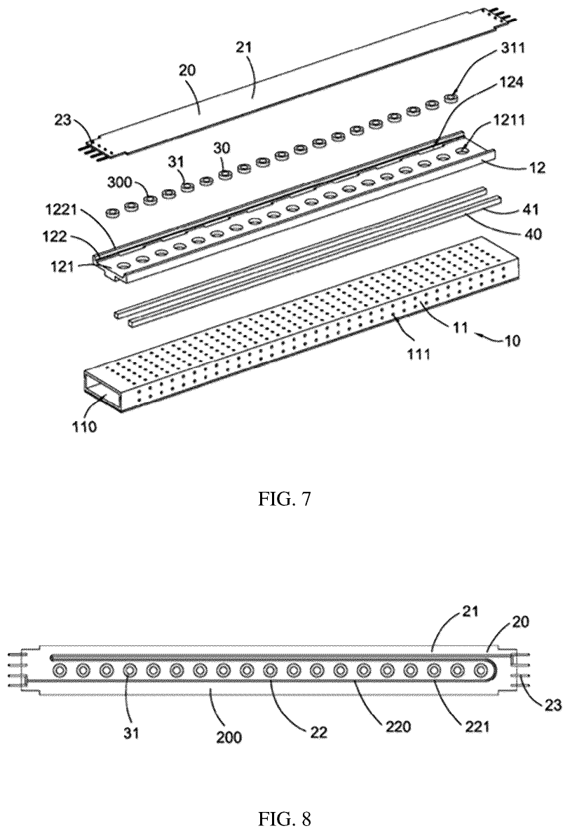

As shown in FIGS. 7 and 8, according to a second variant of the first preferred embodiment of the present invention, the magnet assembly 30 includes a plurality of magnets 31 arranged along a linear direction, each of the plurality of magnets 31 has an intermediate hole 311. The base 121 of the bracket 12 of the shell 10 correspondingly has a plurality of positioning grooves 1211 for accommodating and positioning the magnets 31. When positioning the magnets 31, an upper surface and a lower surface of the magnet 31 with an annular shape form opposite magnetic poles respectively, so that the magnets 31 with annular shapes form the magnetic pole surface 300 located on a plane, so as to interact with the strip-shaped diaphragm surface 200 of the strip-shaped diaphragm 20.

The intermediate hole 311 of the magnet 31 corresponds to the positioning groove 1211 of the base 121. A ventilation hole 124 is formed in the middle of the positioning groove 1211. The ventilation hole 124 corresponds to the intermediate hole 311 of the magnet 31, so that air in the vibration space 123 between the strip diaphragm 20 and the base 121 can flow to the outside. The intermediate holes 311 correspond to each other, thereby allowing the air in the vibration space 123 between the strip-shaped diaphragm 20 and the base 121 to circulate with the outside.

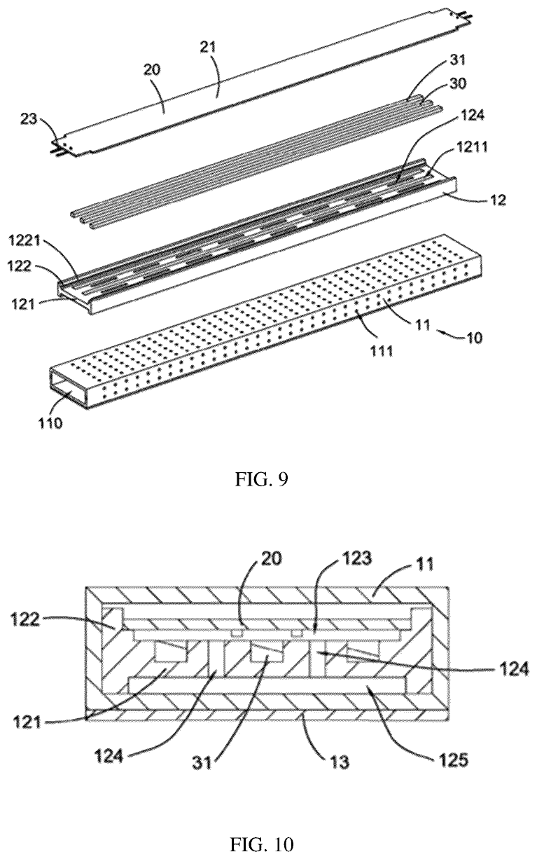

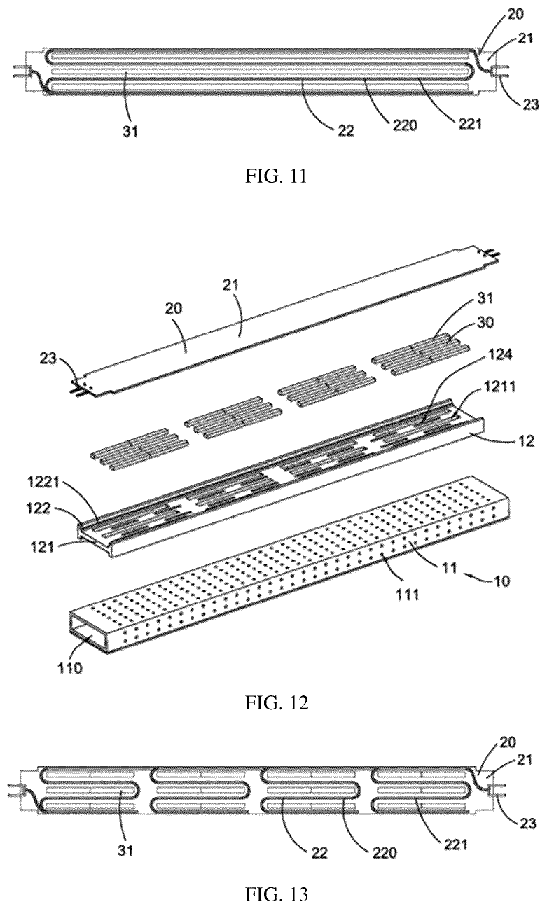

As shown in FIGS. 9 to 11, a line body type sound-producing speaker device according to a second preferred embodiment of the present invention includes a shell 10, a strip-shaped diaphragm 20, and a magnet assembly 30. The strip-shaped diaphragm 20 is in a shape of a line and is installed on the shell 10 along a linear direction. The magnet assembly 30 is also arranged along a linear direction. When the strip-shaped diaphragm 20 generates an electromagnetic field in response to an input of a sound source current signal, an attraction or repulsion action can be generated between the electromagnetic field and the magnetic poles of the magnet assembly 30 to drive the strip-shaped diaphragm 20 to vibrate to produce sound effects.

The strip-shaped diaphragm 20 includes a diaphragm base 21, a conductive circuit 22, and a set of terminals 23. The conductive circuit 22 includes one or more linear circuits 221 extending along a length direction of the strip-shaped diaphragm 20. The magnet assembly 30 includes a plurality of columns of magnets 31. Each of the column of magnets 31 includes a strip magnet 31 and is arranged along a linear direction. The shell 10 includes an outer housing 11 and a bracket 12. The strip-shaped diaphragm 20 and the magnet assembly 30 are assembled on the bracket 12. The outer housing 11 is a tubular housing with a hollow interior forming a strip-shaped receiving cavity 110. The bracket 12, the strip-shaped diaphragm 20, and the magnet assembly 30 are located within the outer housing 11. The bracket 12 includes a base 121 and a fixed frame 122. The magnet 31 of the magnet assembly 30 is fixed to the base 121. The strip-shaped diaphragm 20 is fixed to the fixed frame 122. The base 121 of the bracket 12 of the shell 10 accordingly has a plurality of columns of positioning grooves 1211 with a strip shape to accommodate and position the magnets 31 respectively. The fixed frame 122 includes two fixed ribs 1111 respectively extend protrudingly from two opposite edges of the base 121 to fix the strip-shaped diaphragm 20 above the magnet assembly 30.

The strip-shaped diaphragm 20 is fixed to the fixed frame 122 and forms a vibration space 123 between the strip-shaped diaphragm 20 and the base 121. The magnet assembly 30 and the strip-shaped diaphragm 20 are also spaced apart from each other. The bracket 12 is formed with one or more ventilation holes 124 to connect the vibration space 123 to the outside world, so that when the strip-shaped diaphragm 20 vibrates, the air in the vibration space 123 can be stirred to facilitate transmission of sound.

In this embodiment, the conductive circuit 22 includes a plurality of columns of linear circuits 221 that are integrally connected, such as three columns of linear circuits 221, and each column of the linear circuits 221 is connected to an adjacent row of linear circuits 221. The magnets 31 are arranged in a staggered manner.

As shown in FIGS. 12 and 13, according to a first variant implementation of the second preferred embodiment of the present invention, in this embodiment, the conductive circuit 22 includes a plurality of linear portions 220 electrically connected to each other. Each of the plurality of linear portions 220 includes one or more linear circuits 221. For example, in the embodiment illustrated in FIG. 13, the conductive circuit 22 includes four linear portions 220. Each of the plurality of linear portions 220 includes four linear circuits 221. The four linear circuits 221 are integrally extended and connected, extending like a runway.

The magnet assembly 30 includes three columns of magnets with a strip shape 31, and each of the columns of magnets 31 includes four magnets 31. An intermediate position of every two adjacent linear circuits 221 of the four linear circuits 221 in each linear portion 220 corresponds to one magnet with a strip shape 31, so that the three magnets with a strip shape 31 are respectively located below the gap between two adjacent two linear circuits 221 of the four linear circuits 221. In this way, the linear circuit 221 of each linear portion 220 is located at a position with a relatively strong magnetic field intensity in the magnetic field environment of the corresponding magnet 31. The intermediate two of the four linear circuits 221 of each of the line portions 220 correspond above the positions between the two adjacent magnets 31, respectively.

In addition, the magnetic poles of each row of the three columns of magnets 31 with a strip shape are arranged in the same direction, however the two adjacent columns of the magnets 31 with a strip shape have different magnetic poles on the top sides, that means, for example, the magnetic pole surface 300 formed on the top side of a first column and a third column of the three magnets 31 with a strip shape is a N pole, while the magnetic pole surface 300 formed on a top side of the second column of the magnets 31 is a S pole. So that there is a magnetic field formed by magnetic field lines with specific directions between two adjacent columns of magnets 31 with a strip shape. So that a strong magnetic field is applied to the linear circuits 221 above the position between the two adjacent columns of strip-shaped magnets 31.

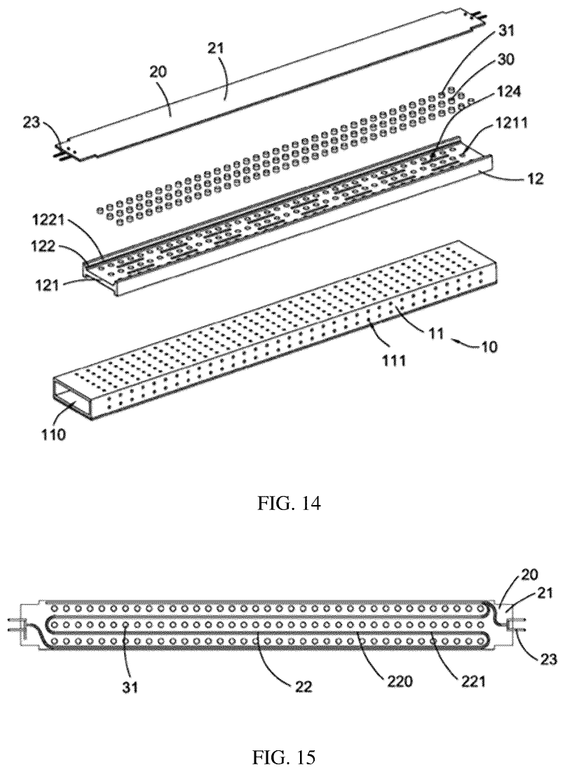

As shown in FIGS. 14 and 15, according to a second variant of the second preferred embodiment of the present invention, the magnet assembly 30 includes a plurality of columns of magnets 31. Each of the plurality of columns of magnets 31 includes a plurality of magnets 31 with a columnar shape arranged along a linear direction. The magnetic poles of two adjacent columns of magnets 31 are arranged in opposite directions. The conductive circuit 22 includes a plurality of columns of linear circuits 221 integrally connected. Each of the plurality of columns of linear circuits 221 are arranged in a staggered manner with the magnets 31 in adjacent columns.

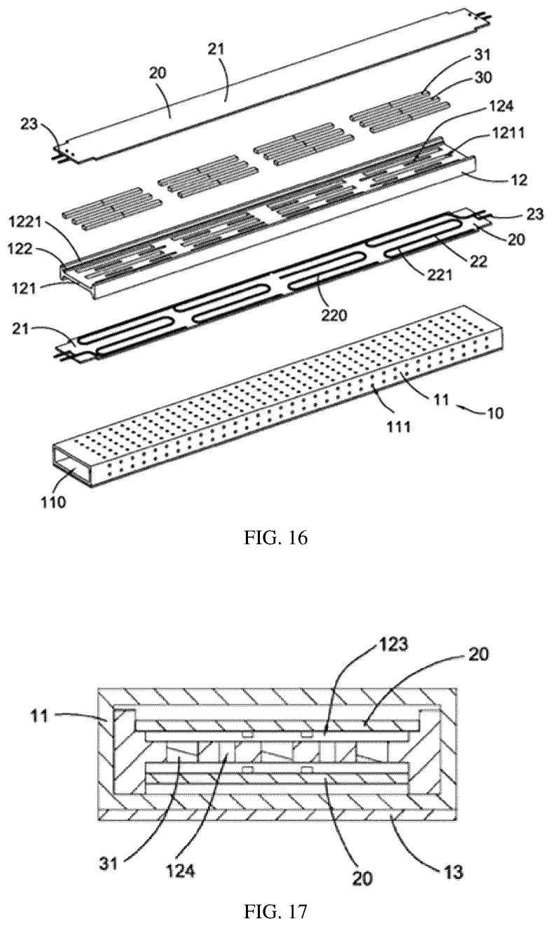

As shown in FIGS. 16 and 17, a line body type sound-producing speaker device according to the third preferred embodiment of the present invention includes a shell 10, two strip-shaped diaphragms 20, and a magnet assembly 30. The two strip-shaped diaphragms 20 are in the shape of a linear body and are installed on the shell 10 along a linear direction and located on opposite sides of the magnet assembly 30. The magnet assembly 30 is also arranged along a linear direction. When the two strip-shaped diaphragms 20 respond to the input of a sound source current signal, they are vibrated by the magnetic field of the magnet assembly 30 to produce sound effects.

Correspondingly, each strip-shaped diaphragm 20 includes a diaphragm base 21, a conductive circuit 22, and a set of terminals 23. The conductive circuit 22 includes one or more linear circuits 221 extends along a length direction of the strip-shaped diaphragm 20. The magnet assembly 30 includes a plurality of columns of magnets 31. Each of the plurality of columns of magnets 31 includes one or more magnets 31 with a strip shape and is arranged along a linear direction. The shell 10 includes an outer housing 11 and a bracket 12. The strip-shaped diaphragm 20 and the magnet assembly 30 are assembled on the bracket 12. The outer housing 11 is a tubular housing with a hollow interior forming a strip-shaped accommodation cavity 110. The bracket 12, the strip-shaped diaphragm 20, and the magnet assembly 30 are both located in the outer housing 11. The bracket 12 includes a base 121 and two fixed frames 122. The two fixed frames 122 are located on opposite sides of the base 121. The magnet 31 of the magnet assembly 30 is fixed to the base 121. The two strip-shaped diaphragms 20 are fixed to the two fixed frames 122 respectively. The base 121 of the bracket 12 of the shell 10 accordingly has a plurality of columns of positioning grooves 1211 with a strip shape for accommodating and positioning the magnets 31. Each of the fixed frames 122 includes two fixed ribs 1111 extend protrudingly from two opposite edges of the base 121 to fix the strip-shaped diaphragm 20 above the magnet assembly 30.

The two strip-shaped diaphragms 20 are fixed to the corresponding fixed frames 122, and each form a vibration space 123 with the base 121. The magnet assembly 30 and the strip-shaped diaphragm 20 are also disposed at intervals from each other. The bracket 12 is formed with one or more ventilation holes 124 to communicate with the vibration space 123, and a peripheral wall of the base 121 can also be formed with the ventilation holes 124, so that when the strip-shaped diaphragm 20 vibrates, the air in the vibration space 123 can be stirred to facilitate transmission of sound.

It is worth mentioning that the two strip-shaped diaphragms 20 are driven by the same magnet assembly 30 and work simultaneously, or they can work alternately periodically, or one of the strip-shaped diaphragms 20 cannot operate. When used again, another strip-shaped diaphragm 20 is activated, thereby extending the service life of the line body type sound-producing speaker device.

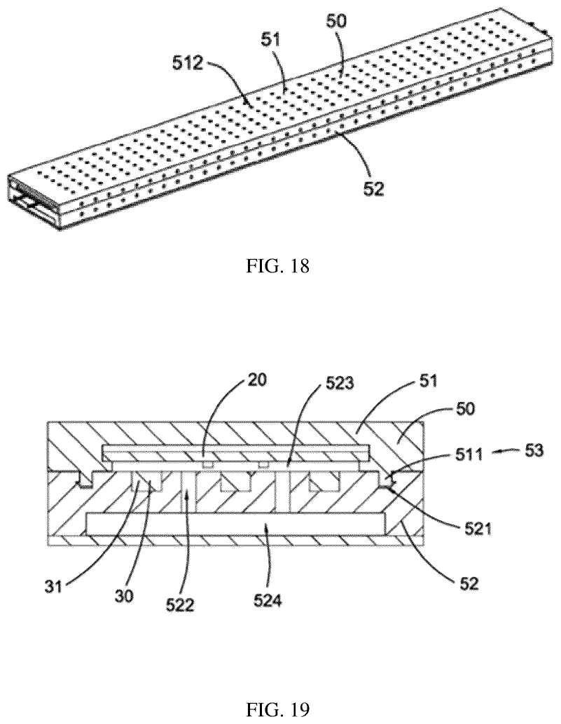

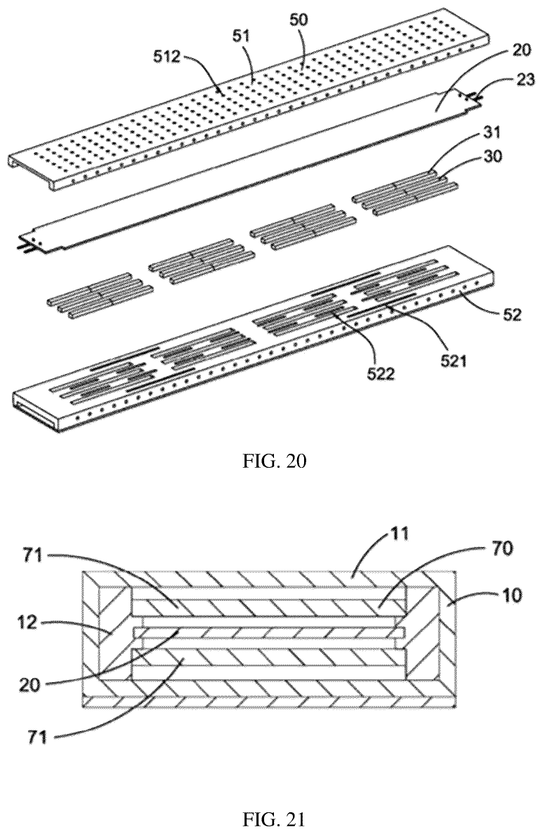

As shown in FIGS. 18 to 20, a line body type sound-producing speaker device according to the fourth preferred embodiment of the present invention includes a shell 50, a strip-shaped diaphragm 20, and a magnet assembly 30. The strip-shaped diaphragm 20 is in a shape of a line and is installed on the shell 50 along a linear direction. The magnet assembly 30 is also arranged along a linear direction. When the strip-shaped diaphragm 20 generates an electromagnetic field in response to an input of a sound source current signal, an attraction or repulsion action can be generated between the electromagnetic field and the magnetic poles of the magnet assembly 30 to drive the strip-shaped diaphragm 20 to vibrate to produce sound effects.

In this embodiment, the shell 50 includes a first shell portion 51 and a second shell portion 52. The strip-shaped diaphragm 20 is installed on the first shell portion 51. The magnet assembly 30 is installed on the second shell portion 52. The first shell portion 51 and the second shell portion 52 can be assembled with each other through suitable connection structures 53 to form an integral housing. Such as the connection structure 53 includes one or more fixed protrusions 511 formed on a bottom of the first shell portion 51 and one or more positioning grooves 521 formed on a top side of the second shell portion 52. It can be understood that the connection structure 53 may also include other structures such as buckles, screws, magnetic attraction, and other structures.

Correspondingly, the strip-shaped diaphragm 20 includes a diaphragm base 21, a conductive circuit 22, and a set of terminals 23. The conductive circuit 22 includes one or more linear circuits 221 extending along a length direction of the strip-shaped diaphragm 20. The magnet assembly 30 includes a plurality of columns of magnets 31. Each of the plurality of columns of magnets 31 includes a magnet 31 with a strip shape and is arranged along a linear direction. The magnetic poles of two adjacent columns of the magnets 31 are arranged in the same direction. On the contrary, the conductive circuit 22 includes a plurality of columns of the linear circuits 221 which are integrally connected, and each of the plurality of columns of the linear circuits 221 and the adjacent column of the magnets 31 are arranged in a staggered manner.

The second shell portion 52 serves as a bracket and is formed with one or more ventilation holes 522 through its thickness to form a vibration space 523 between the strip-shaped diaphragm 20 and the magnet assembly 30. The vibration space 523 is connected to the outside world. So that when the strip-shaped diaphragm 20 vibrates, the air in the vibration space 123 can be stirred to facilitate transmission of sound. The first shell portion 51 may also be formed with a plurality of through holes 512. These through holes 512 may be located on multiple sides, such as the top surface and one or more peripheral surfaces of the first shell portion 51, as ventilation holes. hole.

In this embodiment of the present invention, the manufacturing method of the line body type sound-producing speaker device includes a step of assembling the strip-shaped diaphragm 20, a step of assembling the magnet assembly 30, and a final step of assembling the shell 10.

In the step of assembling the strip-shaped diaphragm 20, the strip-shaped diaphragm 20 is fixed to the first shell portion 51 in a straight state. In the step of assembling the magnet assembly 30, the magnet 31 of the magnet assembly 30 is assembled to the second shell portion 52.

In the final step of assembling the shell 10, the first shell portion 51 to which the strip-shaped diaphragm 20 is assembled and the second shell portion 52 to which the magnet assembly 30 is assembled are assembled, so that the strip-shaped diaphragm 20 and the magnet assembly 30 are spaced apart from each other and the magnetic pole surface 300 on the top side of the magnet assembly 30 and the strip-shaped diaphragm surface 200 of the strip-shaped diaphragm 20 are arranged parallel to each other.

It can be understood that the line body type sound-producing speaker device can be conveniently installed on the environmental surface as a building material, and after the second shell portion 52 on which the magnet assembly 30 is assembled is fixed on the environmental surface, the first shell portion 51 on which the strip-shaped diaphragm 20 is assembled and the second shell portion 52 are assembled by the connecting structure 53, so that the line body type sound-producing effect device can be conveniently installed and expanded on the environmental surface.

As shown in FIG. 21, a linear type sound-emitting speaker device provided according to the fifth preferred embodiment of the present invention includes a shell 10, a strip-shaped diaphragm 20, and a driving assembly 70. The strip-shaped diaphragm 20 is in a shape of a line and is installed on the shell 10 along a linear direction. The driving assembly 70 is also arranged along a linear direction. When the strip diaphragm 20 responds to the input of the sound source current signal, the strip-shaped diaphragm 20 is vibrated by the driving assembly 70 to produce a sound effect.

In this embodiment, the driving assembly 70 includes two driving electrodes 71. The strip-shaped diaphragm 20 can conduct static electricity. The two driving electrodes 71 also extend in a strip shape and have opposite electrodes. The two driving electrodes 71 are converted in polarity by a transformer, so that the strip-shaped diaphragm 20, which is embodied as an electrostatic diaphragm, is alternately applied by suction to vibrate the air to produce a sound effect.

The shell 10 includes an outer housing 11 with a tubular shape and a bracket 12. The strip-shaped diaphragm 20 and the driving electrode 71 are installed on the bracket 12 and located in the outer housing 11.

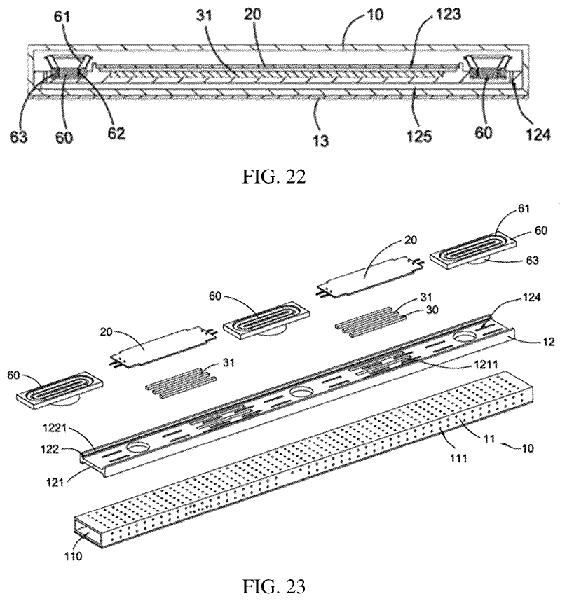

As shown in FIG. 22, a line body type sound-producing speaker device according to the sixth preferred embodiment of the present invention includes a shell 10, one or more strip-shaped diaphragms 20, one or more magnet assemblies 30, and a or a plurality of moving coil speakers 60. Each strip-shaped diaphragm 20 is in a shape of a line and is installed on the shell 50 along a linear direction. The corresponding magnet assembly 30 is also arranged along a linear direction. When the strip-shaped diaphragm 20 generates an electromagnetic field in response to an input of a sound source current signal, an attraction or repulsion action can be generated between the electromagnetic field and the magnetic poles of the magnet assembly 30 to drive the strip-shaped diaphragm 20 to vibrate to produce sound effects.

In this embodiment, the linear speaker device includes two dynamic speakers 60 provided at both ends of the diaphragm 20. Each dynamic speaker 60 includes a drum paper 61, a voice coil 62, and a magnetic return system 63. The drum paper 61 is connected to the shell 10. When a sound source current signal is input into the voice coil 62, it is under the action of the magnetic return system 63. The drum paper 61 is driven to vibrate to produce sound effects.

It can be understood that, in this embodiment of the present invention, the dynamic speaker 60 and a vibrating sound-generating device based on the strip-shaped diaphragm 20 and the magnet assembly 30 are matched with each other to provide a more full-range sound effect. That means, the vibrating sound-generating device based on the strip-shaped diaphragm 20 and the magnet assembly 30 is suitable for providing medium and high frequency sounds. Since the stroke of the drum paper 61 is high, the dynamic speaker 60 can supplement mid-low frequency sound effects, so that the line body type sound-producing speaker device of the present invention can generate a relatively full frequency band sound effect along the linear surface. In addition, the material of the drum paper 61 and the strip-shaped diaphragm 20 can be substantially the same. The drum paper 61 of the dynamic speaker 60 is connected to the voice coil 62, and the conductive circuit 22 of the strip-shaped diaphragm 20 is provided on the diaphragm base 21.

As shown in FIG. 23, according to a variant implementation of the above-mentioned sixth preferred embodiment of the present invention, a linear type sound-emitting speaker device includes one shell 10, two strip-shaped diaphragms 20, two magnet assemblies 30, and three dynamic speakers 60. Each strip-shaped diaphragm 20 has a line body shape and is installed on the shell 50 in a linear direction. The corresponding magnet assembly 30 are also arranged in a linear direction. When the strip-shaped diaphragm 20 responds to the input of a sound source current signal, it is vibrated by the magnetic field of the magnet assembly 30 to produce sound effects. When a sound source current signal is input into the voice coil 62 of each dynamic speaker 60, it electromagnetically interacts with the magnetic return system 63 to drive the drum paper 61 to vibrate to produce a sound effect.

It can be understood that the vibrating sound-generating device based on the strip-shaped diaphragm 20 and the magnet assembly 30 and the dynamic speaker 60 are alternately arranged, which ensures the superiority of the strip-shaped diaphragm 20 in high frequencies, and the dynamic speaker 60 supplements the low-frequency disadvantage of the strip-shaped diaphragm 20. A ring magnet of the dynamic speaker 60 replaces a large number of magnets 31 with a tripe shape of the magnet assembly 30. The use of the speaker greatly reduces the cost and increases the audio performance of the entire line body type sound-producing speaker device.

The dynamic speaker 60, the strip-shaped diaphragm 20, and the magnet assembly 30 can be assembled on the bracket 12 and accommodated in the outer housing 11 with a tubular shape of the shell 10. The connection terminals of the voice coil 62 of the speaker 60 and the connection terminals of the strip-shaped diaphragm 20 can be connected in series to form a mid-low frequency sound and a high-mid frequency sound respectively in response to the same input sound source current signal, thereby producing sound performance. Covers a wider frequency band.

It can be understood that the line body type sound-producing speaker device may include a plurality of dynamic speakers 60 and one or more electrostatic diaphragm speaker devices in the fifth embodiment. The speaker devices that produce sound effects based on the action of a magnetic field in the above-mentioned first to fourth embodiments may also be combined with one or more electrostatic diaphragm speaker devices in the above-mentioned fifth embodiment.

It should be noted that in the device and method of the present application, each component or each step in different embodiments can be decomposed and/or recombined without departing from the principle of the present invention. These decompositions and/or recombinations should be deemed to be included in the inventive concept of the present application.

Those skilled in the art should understand that the embodiments of the present invention shown in the above description and drawings are only embodiments and do not limit the present invention. The object of the present invention has been completely and effectively achieved. The functional and structural principles of the present invention have been shown and described in the embodiments, and the implementation of the present invention may have any variations or modifications without departing from the principles.

1. A line body type sound-producing speaker device, comprising:
a shell;
one or more strip-shaped diaphragms; and
one or more driving assemblies, wherein the strip-shaped diaphragm is in a line body shape and is mounted on the shell along a linear direction, the driving assembly is mounted on the shell along a linear direction and arranged in parallel with the strip-shaped diaphragm at intervals from each other, and when the strip-shaped diaphragm responds to an input of a sound source current signal, the strip-shaped diaphragm is vibrated by the driving assembly to generate a sound effect.

2. The line body type sound-producing speaker device according to claim 1, wherein the strip-shaped diaphragm comprises a diaphragm base, a conductive circuit, and a set of terminals; the conductive circuit is attached to the diaphragm base and is located in a space above the magnet assembly; and the set of terminals are electrically connected to the conductive circuit to supply electrical energy to the conductive circuit and to input the sound source current signal to the conductive circuit.

3. The line body type sound-producing speaker device according to claim 2, wherein the driving component is a magnet component, the magnet component comprises one or more magnets arranged in a linear direction.

4. The line body type sound-producing-emitting loudspeaker device according to claim 3, wherein the magnet of the magnet assembly forms a magnetic pole surface facing the strip-shaped diaphragm, the strip-shaped diaphragm has a diaphragm surface facing the magnet assembly, the magnetic pole surface and the diaphragm surface are parallel to each other, and a linear extension direction of the arrangement of the magnet and an extension direction of the linear circuits are arranged in a staggered manner.

5. The line body type sound-producing speaker device according to claim 3, wherein the magnet assembly comprises a plurality of columns of the magnets, the magnets in the same column are arranged in a same magnetic pole direction, and two adjacent columns of the magnets having opposite magnetic poles on a side facing the strip-shaped diaphragm.

6. The line body type sound-producing speaker device according to claim 5, wherein one of the plurality of columns of the magnets is located below a position between two adjacent of the linear circuits of the corresponding strip-shaped diaphragm.

7. The line body type sound-producing speaker device according to claim 6, wherein the conductive circuit comprises a plurality of linear portions, each of the plurality of linear portions comprises a plurality of the linear circuits, each of the plurality of columns of the magnets comprises a plurality of magnets, and an intermediate position of each two adjacent of the linear circuits of each of the line portions corresponds to one of the magnets with a strip shape.

8. The line body type sound-producing speaker device according to claim 1, wherein the driving component comprises two driving electrodes located on opposite sides of the strip-shaped diaphragm and changing polarity through voltage conversion to drive the strip-shaped diaphragm implemented as an electrostatic diaphragm.

9. The line body type sound-producing speaker device according to claim 1, wherein the shell comprises a tubular housing and a bracket, and the strip-shaped diaphragm and the magnet assembly are installed on the bracket and located in the tubular housing.

10. The line body type sound-producing speaker device according to claim 9, wherein the bracket comprises a base and a fixed frame, the magnet assembly is installed on the base, the strip-shaped diaphragm is installed on the fix frame, a vibration space is formed between the strip-shaped diaphragm and the base, the base has one or more ventilation holes, a communication space is formed on a bottom side of the base, and the vibration space and the communication space are connected through the ventilation holes.

11. The line body type sound-producing speaker device according to claim 1, wherein the shell comprises a first shell portion and a second shell portion, the strip-shaped diaphragm is installed on the first shell portion, the magnet assembly is mounted on the second shell portion, and the first shell portion and the second shell portion are assembled.

12. The line body type sound-producing speaker device according to claim 3, wherein the magnet is one selected from a group consisting of a strip magnet, a columnar magnet, and a ring magnet.

13. The line body type sound-producing speaker device according to claim 1, further comprising two strip-shaped diaphragms, wherein the two strip-shaped diaphragms are located on opposite sides of the same magnet assembly.

14. The line body type sound-producing speaker device according to claim 1, further comprising one or more dynamic speakers installed on the shell to jointly respond to the input of the sound source current signal with the strip-shaped diaphragm to produce sound effects at the same time.

15. The line body type sound-producing speaker device according to claim 14, when the line body type sound-producing speaker device comprises a plurality of the dynamic speakers, the plurality of dynamic speakers are alternately linearly arranged with a plurality of loudspeakers formed by the strip-shaped diaphragm and the driving assembly.

16. The line body type sound-producing speaker device according to claim 1, further comprising a light source, and the light source comprises one or more light bars along a length direction of the shell.

17. The line body type sound-producing speaker device according to claim 16, wherein the shell comprises a tubular housing and a bracket, the light bar is installed on the bracket and located in the tubular housing, and the tubular housing has a plurality of through holes.

18. The line body type sound-producing speaker device according to claim 3, wherein the conductive circuit comprises one or more linear circuits extending along a length direction of the strip-shaped diaphragm and located in a magnetic field environment of the magnet of the magnet assembly; and when the set of terminals inputs the sound source current signal, the linear circuits are affected by the magnetic field of the magnet of the magnet assembly, causing the diaphragm base to vibrate accordingly and produce sound.

19. The line body type sound-producing speaker device according to claim 9, wherein the outer housing is a tubular housing and extends in an elongated strip, and both the strip diaphragm and the magnet assembly housed within the tubular housing match the length of the tubular housing.

20. The line body type sound-producing speaker device according to claim 10, wherein a vibration space is formed between the strip-shaped diaphragm and the base, the base has one or more ventilation holes, a communication space is formed on a bottom side of the base, and the vibration space and the communication space are connected through the ventilation holes.
